(19) United States
(12) Patent Application Publication
(10) Pub. No.: US 2010/0312543 A1
(43) Pub. Date: Dec. 9, 2010

(54) COMPUTER SYSTEM FOR EXECUTING EMULATOR EMULATING RANDOM ACCESS STORAGE MEDIUM ON VIRTUAL SEQUENTIAL ACCESS STORAGE MEDIUM

(75) Inventor: Tatsumi MATSUDA, Yokohama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/510,065

(22) Filed: Jul. 27, 2009

(30) Foreign Application Priority Data
Jun. 4, 2009 (JP) 2009-134642

(51) Int. Cl. G06F 9/455; G06F 12/00

(52) U.S. Cl. 703/24; 711/112; 711/E12.001; 707/E17.01; 707/E17.044

(57) ABSTRACT

When an unnecessary data object exists in a virtual sequential medium, an emulator invalidates a random medium section storing the unnecessary data object in order to allow other data to be stored therein. When providing the unnecessary data object to a higher-level program, the emulator provides predetermined control information of smaller size than the unnecessary data object, in place of the unnecessary data object.

### CROSS-REFERENCE TO PRIOR APPLICATION

This application relates to and claims the benefit of priority from Japanese Patent Application number 2009-134642, filed on Jun. 4, 2009 the entire disclosure of which is incorporated herein by reference.

### BACKGROUND

The present invention generally relates to technology that emulates a random medium (a random access storage medium) on a virtual sequential medium (a virtual sequential access storage medium).

As this type of technology, for example, Laid-open Japanese Patent Application Publication No. 2008-123444 discloses technology that emulates a magnetic disk on a virtual tape which is a virtual magnetic tape. Access to the virtual tape is actually made to the magnetic disk. Therefore, higher speed access can be made to the virtual tape than to an actual magnetic tape (to be referred to as “actual tape” hereinafter).

Note in Laid-open Japanese Patent Application Publication No. 2008-123444 that the data stored in the magnetic disk is retreated to the actual tape, in order to eliminate the decrease in efficiency of the capacity of the magnetic disk (decrease in the capacity of the free storage area).

### SUMMARY

In this type of technology, in general, the emulator for emulating the magnetic disk on the virtual tape is a low-order computer program that uses the actual tape. Thus, a higher-level computer program of the emulator (“higher-level program” hereinafter) uses the virtual tape.

The high-level program remains unaffected by the virtual tape. In other words, the higher-level program accesses the virtual tape in the same way as accessing the actual tape. As a result, the higher-level program can sequentially write data into the virtual tape or sequentially read the data from the virtual tape.

In general, the higher-level program cannot invalidate a part of the actual tape. Specifically, for example, even when there is an unnecessary data object in the actual tape, the higher-level program cannot delete the unnecessary data object only. In other words, the higher-level program cannot delete the data object within the actual tape unless all of the data objects stored in the actual tape become unneeded.

The virtual tape is handled as with the actual tape. For this reason, even when there is an unnecessary data object in the virtual tape, the higher-level program cannot delete the unnecessary data object only, as in the actual tape. As a result, the unnecessary data object remains in the magnetic disk, and the storage area having this data object stored therein cannot be used effectively, meaning that the efficiency of the capacity is degraded.

Even if only the unnecessary data object can be deleted from the magnetic disk by using some kind of method, it affects the higher-level program. Specifically, the data objects that should be sequentially read from the virtual tape can no longer be read, and, as a result, the higher-level program detects an error.

Such problems also occur when a random access storage medium is not a magnetic disk.

Therefore, an object of the present invention is to improve the efficiency of the capacity of a random medium without affecting a higher-level program of the emulator that emulates the random medium on a virtual sequential medium.

When there is an unnecessary data object in the virtual sequential medium, the emulator invalidates a random medium section having the unnecessary data object stored therein, so that other data can be stored. When providing the unnecessary data object to a higher-level program, the emulator provides, in place of the unnecessary data object, predetermined control information of smaller size than the unnecessary data object.

At least either one of the emulator and the higher-level program may be installed from a distant server or a storage medium (for example, a CD-ROM, a DVD (Digital Versatile Disk, or other portable storage medium).

The emulator and the higher-level program are stored in a storage resource of a computer system and executed by processors within the computer system. The computer system has one or more computers. The processor executing the emulator may be different from the processor executing the higher-level program. These processors may exist in different devices (for example, the computers or switch devices).

A storage system coupled to the computer system has a random medium. The storage system has one or more storage devices. At least one of the storage devices can be provided with the random medium

Any type of object, such as a file or the entire virtual tape, may be adopted as a data object.

### BRIEF DESCRIPTION OF THE DRAWINGS

FIG. 1 shows a data processing system according to an embodiment of the present invention;

FIG. 2A shows a functional block of a device management program 130;

FIG. 2B shows a functional block of an emulator 140;

FIG. 3A shows the relationship between files within a virtual tape 200 and files within a magnetic disk 156;

FIG. 3B shows a configuration of a file management table 144;

FIG. 3C shows a configuration of a virtual tape management table 145;

FIG. 4A shows the arrangement of files VT1 to VT4 of a virtual tape (VTAPE 1);

FIG. 4B shows the arrangement of files VT5 to VT7 of a virtual tape (VTAPE 2);

FIG. 4C shows magnetic disks (DISK 1) to (DISK 4) having the files VT1 to VT7 stored therein;

FIG. 4D shows the file management table 144 that is updated when a file (VTAPE 1. DS 1) becomes unnecessary;

FIG. 5A shows the virtual tape management table 145 that is updated when the file (VTAPE 1. DS 1) is unnecessary;

FIG. 5B shows a state in which a storage area part is invalidated, the storage area part being a part of a storage area in which the unnecessary file is stored and having data other than EOF data stored therein;

FIG. 5C shows a flow of processing performed by the emulator 140;

FIG. 6A shows an example of file generation management;

FIG. 6B shows a state in which a file of generation 1 becomes unnecessary at the point of time when a file of generation 4 is stored in the virtual tape; and

FIG. 6C shows a state in which a higher-level program 700 has a function to notify the emulator 140 of the unnecessary file.

### DETAILED DESCRIPTION OF THE EMBODIMENTS

An embodiment of the present invention is described hereinafter with reference to the drawings. Note that the following descriptions express each information item as “xxx table,” but each information item may be expressed in the form other than the table data structure.

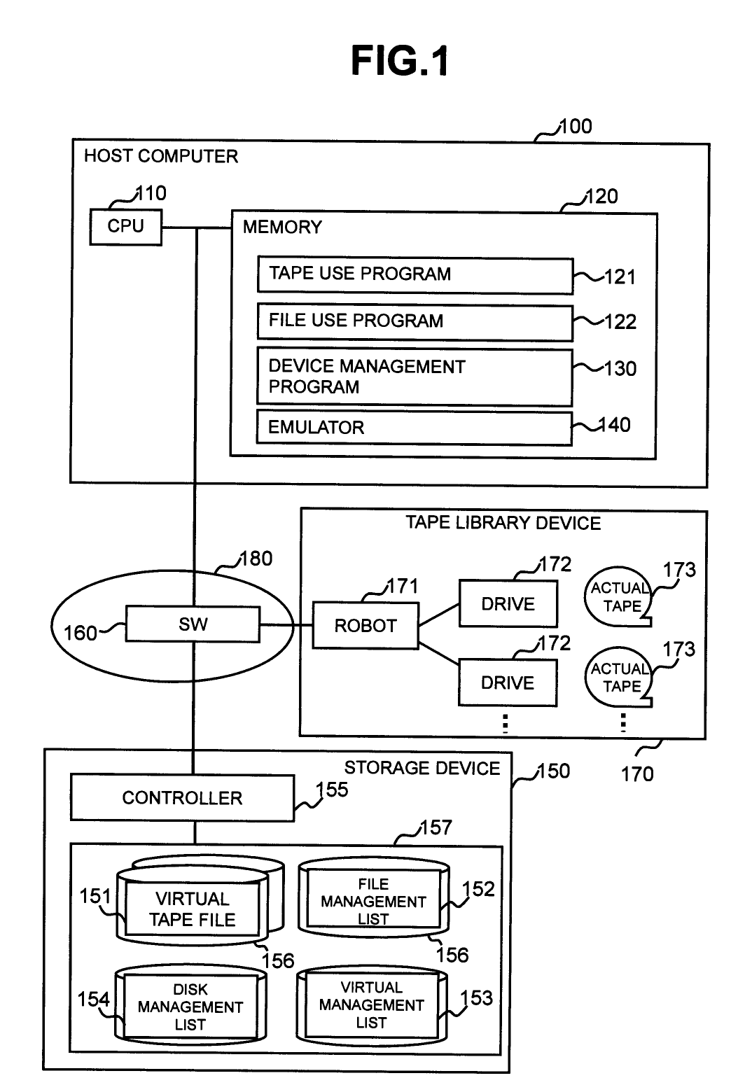

FIG. 1 shows a data processing system according to the embodiment of the present invention.

A host computer 100, a tape library device 170 and a storage device 150 are coupled to a communication network 180. Only one of each of the devices 100, 170 and 150 is shown, but at least one of them may be provided in plurality.

The communication network 180 comprises one or more switch devices 160. The communication network 180 is, for example, an FC (Fiber Channel) network or an IP (Internet Protocol) network.

The tape library device 170 has, for example, a plurality of actual tapes (actual magnetic tapes) 173, a plurality of drives 172 corresponding to the actual tapes 173, and a robot 171. The robot 171 sets an actual tape 173 selected from among the plurality of actual tapes 173 in a drive 172 selected from among the plurality of drives 172. For example, all or some of data objects that are stored in the actual tape 173 set in the drive 172 are loaded into any of virtual tapes. Further, for example, all or some of the data objects within the virtual tape are copied to the actual tape 173 set in the drive 172.

The storage device 150 has a controller 155 and a magnetic disk group 157.

The magnetic disk group 157 has a plurality of magnetic disks (for example, hard disk drives) 156. One or more files stored in one virtual tape (virtual magnetic tape) are actually stored in at least one magnetic disk 156. Note that the magnetic disk group 157 may have a plurality of RAID (Redundant Array of Independent (or Inexpensive) Disks) groups. Each RAID group has two or more magnetic disks 156. One or more logical volumes are formed based on the RAID groups. One or more files stored in one virtual tape may be stored in at least one logical volume.

The controller 155 controls an access made from the host computer 100 to the magnetic disks 156. The controller 155 is, for example, a circuit board having a CPU, a memory, and the like.

The host computer 100 has a memory 120 and a CPU (Central Processing Unit) 110 coupled to the memory 120. The memory 120 stores therein a tape use program 121, a file use program 122, a device management program 130 and an emulator 140. These computer programs 121, 122, 130 and 140 are executed by the CPU 110. In the following description, the processing performed by the computer programs is actually executed by the CPU that executes these computer programs.

The tape use program 121 is a business program that uses the whole virtual tapes without regard for the files.

The file use program 122 is a business program that uses the files contained in the virtual tape.

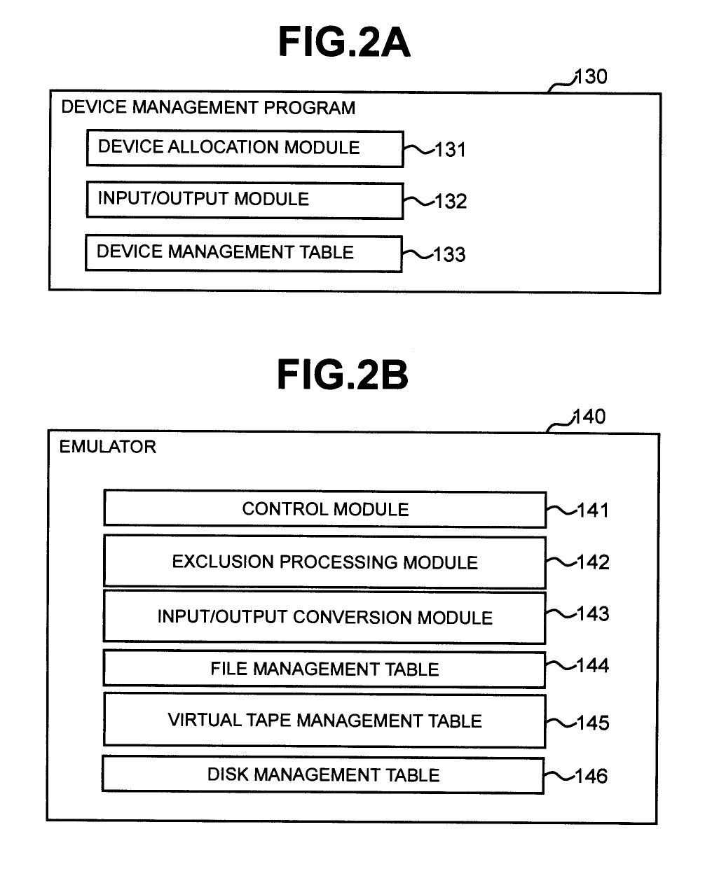

The device management program 130 is a program that performs various control processes relating to the devices coupled to the host computer 100. The device management program 130 has a plurality of modules, such as a device allocation module 131 and an input/output module 132, as shown in FIG. 2A. In addition, the device management program 130 manages a device management table 133.

The device allocation module 131 performs allocation processing for allocation with respect to the storage device 150.

The input/output module 132 performs input/output (access) to/from the virtual tapes.

The device management table 133 has information on the devices coupled to the host computer 100.

The higher-level program of the emulator 140 has the abovementioned tape use program 121, file use program 122 and device management program 130. Specifically, the program 121 or 122 issues to the device management program 130 an input/output instruction specifying a desired virtual tape or a file within the virtual tape. The input/output module 132 of the program 130 receives the input/output instruction from the program 121 or 122, and, in response to it, outputs the input/output instruction specifying a virtual tape or file. The emulator 140 receives the output input/output instruction.

The emulator 140 emulates at least one magnetic disk 156 of the magnetic disk group 157 on a plurality of (or one) virtual tapes, and carries out various control processes relating to the storage device 150 (because the storage device 150 is the basis for the virtual tapes, the storage device 150 may be expressed as “virtual tape device”). As shown in FIG. 2B, the emulator 140 has a plurality of modules, such as a control module 141, an exclusion processing module 142 and an input/output conversion module 143. Moreover, the emulator 140 manages a file management table 144, a virtual tape management table 145 and a disk management table 146.

The control modules 141 carries out invalidation processing.

The exclusion processing module 142 performs exclusion control on the virtual tape or the file. Specifically, for example, the exclusion processing module 142 sets a certain virtual tape as a target to be excluded, while invalidating an unnecessary file within the virtual tape, thereby preventing input/output to/from the virtual tape (when invalidation of the unnecessary file is ended, the virtual tape is exempted from the exclusion target).

The input/output conversion module 143 converts and input/output to/from the virtual tape into an input/output to/from the magnetic disk 156. Specifically, for example, when the virtual tape or file that is specified by the input/output instruction from the device management program 130 is not the target of exclusion, the input/output conversion module 143 transmits to the storage device 150 the input/output instruction specifying the magnetic disk 156 corresponding to this virtual tape or file, in response to the input/output instruction output from device management program. Consequently, in response to this input/output instruction, the controller 155 within the storage device 150 carries out input/output with respect to the magnetic disk 156 specified by the instruction.

The file management table 144 has information indicating which file is stored in which magnetic disk. The file management table 144 is stored in a file management list 152 of any of the magnetic disks 156 and read by the memory 120 when the storage device 150 is used.

The virtual tape management table 145 has information indicating which file is stored in which virtual tape. The virtual tape management table 145 is stored in a virtual tape management list 153 of any of the magnetic disks 156 and read by the memory 120 when the storage device 150 is used.

The disk management table 146 has information on each magnetic disk 156 (for example, information indicating which one of the magnetic disks 156 is the basis for the virtual tapes, and which one of the management lists 152, 153 and 154 is stored in which one of the magnetic disks 156). The disk management table 146 is stored in the disk management list 154 within any of the magnetic disks 156 and read by the memory 120 when the storage device 150 is used.

The following describes how writing is performed from the host computer 100 to the magnetic disks 156. The device management program 130 receives from the program 121 or 122 a write instruction specifying a write destination virtual tape, as well as a file to be written. The input/output module 132 of the program 130 delivers the write instruction and the file to be written, to the emulator 140. The input/output conversion module 143 of the emulator 140 transmit, to the storage device 150, a write request specifying a write destination magnetic disk 156 and the file to be written. In response to the write request, the controller 155 of the storage device 150 stores the file to be written, into a specified magnetic disk 156.

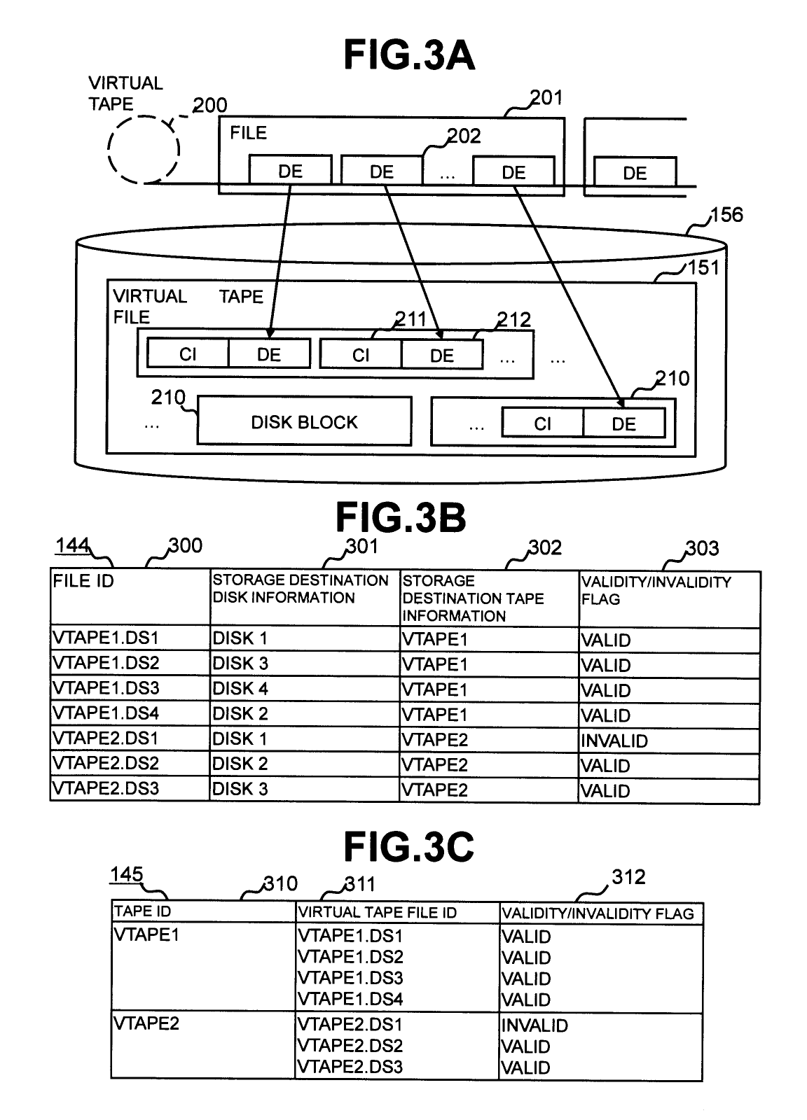

FIG. 3A shows the relationship between files within the virtual tape 200 and files within the magnetic disk 156. Hereinafter, the file stored in the magnetic disk 156 is sometimes referred to as “virtual tape file.”

In the virtual tape 200, a plurality of files 201 are arranged sequentially. A data element (DE) configuring each file 201 is stored in each tape block 202.

The files 201 are stored in the magnetic disk 156 as virtual tape files 151. Each virtual tape file 151 has control information (CI) for each data element (DE). In other words, the virtual tape file 151 has a plurality of data sets (a set of data element (DE) and control information (CI)). The control information (CI) has information relating to the data element (DE) within the data set corresponding to this control information (CI) (for example, the ID (e.g., number) of the tape block 202 in which this data element (DE) is stored). Each control information item (CI) is generated by the input/output conversion module 143 and stored in the magnetic disk 156.

In the present embodiment, the size of each disk block 210 is greater than the size of the tape block 202, and the plurality of data sets (a set of data element (DE) and control information (CI)) are stored in one disk block 210. However, the storing format is not limited to the format described above. For example, one data set may be stored in the plurality of disk blocks 210. Further, for example, the files may be stored in the magnetic disk 156 without having the control information (CI) added thereto. In addition, either the size of the disk block 210 or the size of the tape block 202 may be the integral multiple of the other (e.g., same size) (in this case, the control information (CI) may not be added).

FIG. 3B shows a configuration of the file management table 144.

The file management table 144 has a file ID 300, storage destination disk information 301, storage destination tape information 302 and a validity/invalidity flag 303, for each file. Hereinafter, one file (to be referred to as “target file” in the explanation on FIG. 3B) is taken for example to describe these elements 300 to 303.

The file ID 300 is information for identifying the target file. The file ID 300 has, for example, a file name.

The storage destination disk information 301 is information on the magnetic disk, out of information on a storage destination of the target file. The information 301 has, for example, the name of a target file storage destination magnetic disk. The information 301 may have information indicating where in the magnetic disk the target file is stored, i.e., the ID (e.g., address) of the first disk block out of a disk block group having the target file stored therein, as well as the number of disk blocks configuring the disk block group having the target file stored therein.

The storage destination tape information 302 is information on the virtual tape, out of the information on the target file storage destination. The information 302 has, for example, the name of a target file storage destination virtual tape. The information 302 may have information indicating where in the virtual tape the target file is stored, i.e., the ID (e.g., number) of the first tape block out of a tape block group having the target file stored therein, as well as the number of tape blocks configuring the tape block group having the target file stored therein.

The validity/invalidity flag 303 is a flag representing validity or invalidity of the target file.

FIG. 3C shows a configuration of the virtual tape management table 145.

The virtual tape management table 145 has a tape ID 310, a virtual tape file ID 311 and a validity/invalidity flag 312, for each file. Hereinafter, one virtual tape (to be referred to as “target virtual tape” in the explanation on FIG. 3C) is taken for example to describe these elements 310 to 312.

The tape ID 310 is information for identifying the target virtual tape. The tape ID 310 has, for example, the name of the virtual tape.

The virtual tape file ID 311 exists in each virtual tape file corresponding to each file stored in the target virtual tape. The virtual tape file ID 311 has the name of each virtual tape file. In the present embodiment, the name of each virtual tape file is the same as the name of each file stored in the virtual tape, but may be different from the name of each file.

The validity/invalidity flag 312 exists in each file stored in the target virtual tape. The flag 312 is the same as the validity/invalidity flag 303 described above.

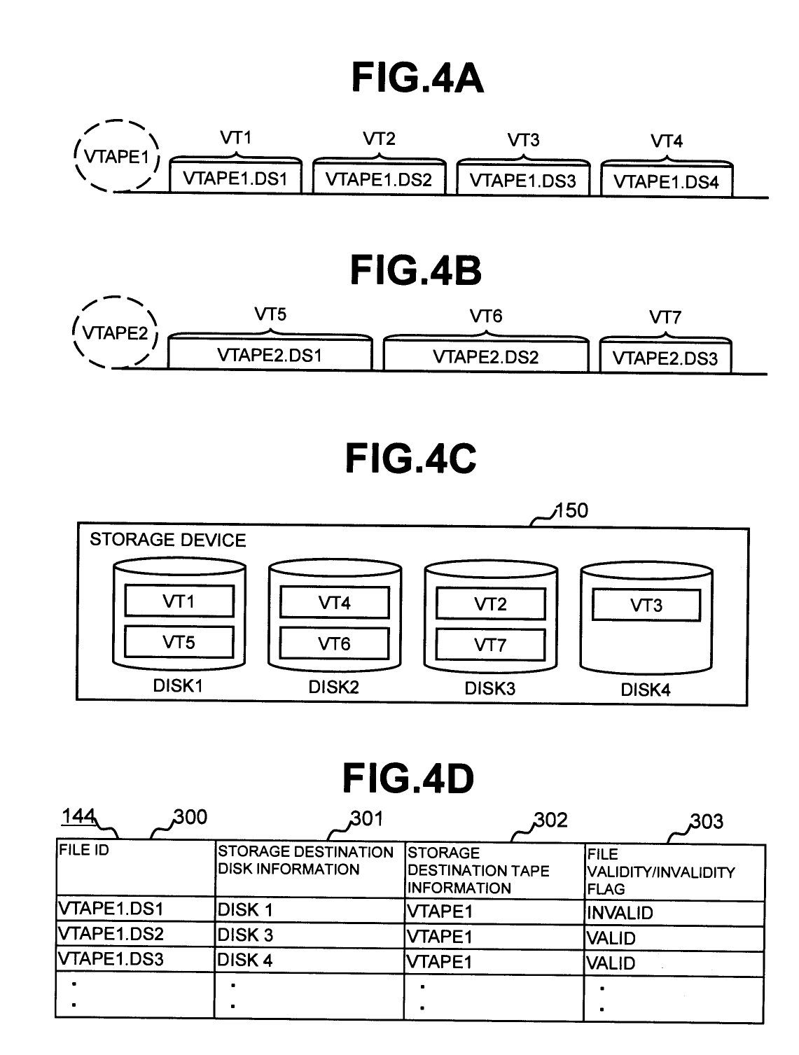

In the tables 144 and 145 shown in FIGS. 3B and 3C, the sequence of the plurality of file IDs 300 and the sequence of the plurality of virtual tape files IDs 311 are the same as the sequence of the virtual tape files in the virtual tape. Specifically, as shown in FIG. 4A, in a virtual tape (VTAPE 1) four virtual tape files VT 1 to VT 4 are stored sequentially from the front. As shown in FIG. 4B, in a virtual tape (VTAPE 2) three virtual tape files VT 5 to VT 7 are stored sequentially from the front (the character string within each virtual tape file represents the file name of each virtual tape file). According to the table 144 shown in FIG. 3B, the files VT 1 to VT 7 are stored in the magnetic disks (DISK 1) to (DISK 4), as shown in FIG. 4C.

The emulator 140 performs such storage (file allocation).

For example, the emulator 140 receives, from the input/output module 132 of the device management program 130, a write instruction specifying the virtual tape (VTAPE 1) and four files to be written. The input/output conversion module 143 of the emulator 140 carries out the following processing for each of the files to be written:

(W1) Divide the files to be written into one or more data elements and convert them to virtual tape files in which the control information is added for each data element;

(W2) Write the data elements and control information obtained after conversion into any magnetic disk (specifically, transmit a write request specifying a write destination magnetic disk and the virtual tape files to the storage device 150); and

(W3) Update the tables 144 and 145 (at this moment, the values of the validity/invalidity flags corresponding to the stored virtual tape files are values representing validity). Here, the virtual tape file VT 1 is stored in the magnetic disk (DISK 1), the virtual tape file VT 2 in the magnetic disk (DISK 3), the virtual tape file VT 3 in the magnetic disk (DISK 4), and the virtual tape file VT 4 in the magnetic disk (DISK 2).

The following describes how reading is performed.

For example, the emulator 140 receives a read instruction specifying the virtual tape (VTAPE 1), from the input/output module 132 of the device management program 130. The input/output conversion module 143 of the emulator 140 carries out the following processing:

(R1) Refer to the table 145 and specify a file that is not yet read from the virtual tape (VTAPE 1) and is located nearest to the front file;

(R2) Refer to the table 144 and specify a place in which the file specified in (R1) is actually stored;

(R3) Read the file specified in (R1) from the specified place (magnetic disk) and delivers it to the device management program 130;

(R4) Determine whether or not all of the files to be read are read; and

(R5) Carry out (R1) if the result of determination in (R4) is negative, or end the processing if the result of determination in (R4) is positive. As a result, the virtual tape files are read in order of VT 1, VT 2, VT 3 and VT 4 and delivered to the device management program 130. The input/output module 130 of the device management program 130 delivers the virtual tape files to a read specification source (the tape use program 121, for example) in the order in which the virtual tape files are read.

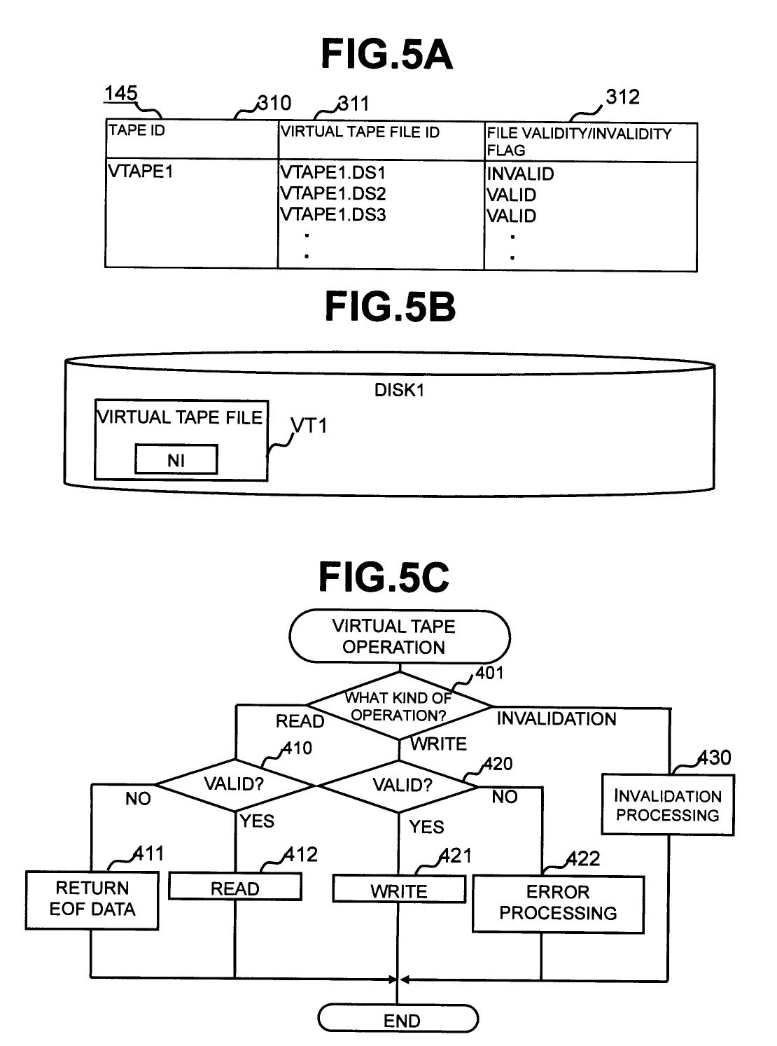

Suppose it is detected that the file VT 1 out of the abovementioned virtual tape files VT 1 to VT 7 becomes unnecessary. In this case, the control module 141 of the emulator 140 updates the values of the validity/invalidity flags 303 and 312 corresponding to the file VT 1 (VTAPE 1. DS 1) from the value representing “valid” to a value representing “invalid,” as shown in FIGS. 4D and 5A.

Once the values of the validity/invalidity flag 303 and 312 are updated to the values representing “invalid,” the control module 141 of the emulator 140 invalidates (releases) a storage area section having data other than the minimum required data (NI), from the storage area having the file VT 1 (VTAPE 1. DS 1) stored therein, as shown in FIG. 5B. Consequently, this storage area section can store other data (another virtual tape file or a part of it) therein.

“The minimum required data” is data in the smallest size in which the file read source (the program 121 or 122, for example) cannot detect an error even when it receives it instead of the unnecessary file VT 1. Examples of this type of data include EOF (End Of File) data having an EOF of the file VT 1. The EOF data may be the EOF itself. Further, label information corresponding to the file may be contained as the minimum required data. As the label information, for example, the file name or information useful for a higher-level application that uses the file, but other types of information may be the label information.

When the emulator 140 receives a read instruction to read the unnecessary file VT 1, the input/output conversion module 143 of the emulator 140 refers to the tables 144 and/or 145 to determine whether the file VT 1 is valid or invalid. Because the file VT 1 is invalid, the module 143 provides the device management program 130 with the minimum required data instead of the file VT 1. The minimum required data is transmitted from the device management program 130 to the read instruction source (program 121 or 122).

The control module 141 may invalidate all of the storage areas having the unnecessary file VT 1 stored therein. In this case, for example, the control module 141 may store the minimum required data in a magnetic disk different from the magnetic disk (DISK 1) having the file VT 1 stored therein. Alternatively, in this case, for example, the minimum required data may not be stored in any magnetic disk. In this case, for example, when the emulator 140 receives the read instruction to read the unnecessary file VT 1, the emulator 140 can provide the device management program 130 with the minimum required data instead of the file VT 1, without accessing the magnetic disk. The minimum required data may be generated every time when it is provided to the device management program 130, or may be prepared in a specific place of the host computer 100 (the memory 120, for example) beforehand and then provided from this place.

FIG. 5C shows a flow of processing performed by the emulator 140. In the following description, the minimum required data described above is the EOF data.

The emulator 140 receives some sort of instruction from the higher-level program. This instruction is received from any of the device management program 130, file use program 122 and tape use program 121. Note that the input/output instruction (write/read instruction) is sent from the program 121 or 122 to the emulator 140 via the device management program 130.

The emulator 140 determines what kind of operation to perform based on the received instruction (step 401). When performing a read operation, step 410 is carried. When performing a write operation, step 420 is carried out. When performing invalidation operation, step 430 is carried out.

In step 410, the emulator 140 refers to the validity/invalidity flags 303 and/or 312 corresponding to the file to be read, and determines whether the file is valid or invalid. When it is determined that the file is valid (step 410: YES), the emulator 140 reads the file from the magnetic disk and delivers the file to the higher-level program (step 412). On the other hand, when it is determined that the file is invalid (step 410: NO), the emulator 140 delivers required EOF data instead of the file, to the higher-level program (step 411).

In step 420, the emulator 140 refers to the validity/invalidity flags 303 and/or 312 corresponding to the file to be read, and determines whether the file is valid or invalid. When it is determined that the file is valid (step 420: YES), the emulator 140 writes the file into the magnetic disk (step 421). On the other hand, when it is determined that the file is invalid (step 420: NO), the emulator 140 returns an error to the higher-level program (step 422).

In step 430, the emulator 140 performs invalidation processing. Specifically, the emulator 140 performs the following processing:

(I1) Update the values of the validity/invalidity flags 303 and 312 corresponding to the unnecessary file to the value representing “invalid”;

(I2) Refer to the tables 144 and/or 145 to specify the virtual tape having the unnecessary file stored therein, and set the exclusion target as the virtual tape;

(I3) Invalidate a storage area section having data other than the EOF data stored therein, from the storage area having the unnecessary file stored therein (storage area within the magnetic disk); and

(I4) Cancel the setting performed in (I2) above (cancel the setting of exclusion).

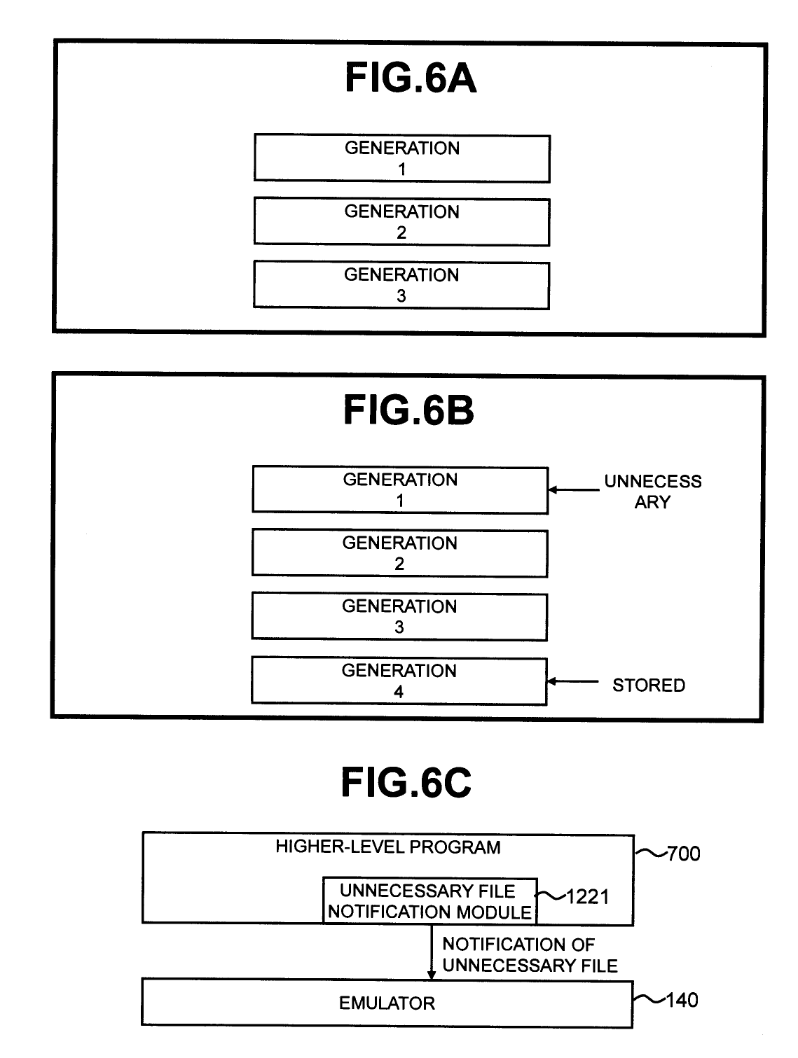

Note that the unnecessary file is notified from the higher-level program (at least one of the programs 121, 122 and 130) to the emulator 140. Specifically, for example, the higher-level program manages the generations of the files, as shown in FIG. 6A. For example, when a file of generation n is stored in the virtual tape, the higher-level program notifies of the emulator 140 a file of generation older than a file of generation (n−k), as the unnecessary file. According to the example shown in FIG. 6B, n is 4 and k is 2. Specifically, when a file of generation 4 is stored, a file of generation 1 is detected as the unnecessary file. As shown in FIG. 6C, a higher-level program 700 has an unnecessary file notification module 1221, which notifies the emulator 140 of information (e.g., the file ID) on the detected unnecessary file (the file of generation 1). The emulator 140 then carries out the abovementioned invalidation processing on the file (the file of generation 1) specified by the notified information, as the unnecessary file.

According to the embodiment described above, out of the storage area having the unnecessary file stored therein, the storage area section having data other than the minimum required data stored therein is invalidated (released), whereby this storage area section can store other data. At the time of file reading, the higher-level program 700 does not detect an error, because, instead of the unnecessary file, the minimum required data is provided from the emulator 140 to the higher-level program 700. For this reason, the efficiency of the capacity of the magnetic disk can be enhanced without affecting the higher-level program 700.

Although the above has described an embodiment of the present invention, the present invention is not limited to this embodiment, and various changes may be made without departing from the scope of the present invention.

What is claimed is:

1. A computer system, which is coupled to a storage system including a random medium which is a random access storage medium, the computer system comprising:
a storage resource; and
a processor coupled to the storage resource,
wherein the storage resource stores therein:
an emulator that emulates the random medium on a virtual sequential medium which is a virtual sequential access storage medium; and
a higher-level program that is a higher-level computer program of the emulator and uses the virtual sequential medium,
the processor executes the emulator and the higher-level program,
the higher-level program instructs to perform reading from the sequential medium,
the emulator reads, from the random medium, a plurality of data objects within the virtual sequential medium in sequential order in which the data objects are arranged in the virtual sequential medium, in response to the read instruction,
the higher-level program is configured to prevent the sequential medium from being partially invalidated, and wherein
the emulator:
(A) invalidates a random medium section that stores an unnecessary data object in order to allow other data to be stored therein, when the unnecessary data object exists in the virtual sequential medium; and
(B) provides, in place of the unnecessary data object, predetermined control information of smaller size than the unnecessary data object to the higher-level program when providing to the higher-level program the unnecessary data object.

2. The computer system according to claim 1, wherein
the random medium is a magnetic disk,
the virtual sequential medium is a virtual tape which is a virtual magnetic tape,
the data object are a file,
the predetermined control information is End of File (EOF) data having an EOF indicating that the number of data elements comprising the file is zero,
the storage resource stores management information therein,
the management information has tape/file information indicating which file is stored in which virtual tape, file/disk information indicating which file is stored in which magnetic disk, and validity/invalidity information indicating validity/invalidity for each file,
a file stored in the magnetic disk has control information for each of data blocks configuring a file stored in the virtual tape,
the higher-level program notifies the emulator of the unnecessary file, and wherein
the emulator:
in the (A), updates the validity/invalidity information corresponding to the unnecessary file notified from the higher-level program, from information representing validity to information representing invalidity, stores the EOF data of the unnecessary file in the magnetic disk; and
in the (B), when providing a certain file to the higher-level program, specifies that the certain file is the unnecessary file based on the validity/invalidity information corresponding to the certain file, reads the EOF data of the unnecessary file from the magnetic disk, and provides to the higher-level program the EOF data in place of the unnecessary file.

3. The computer system according to claim 2, wherein
the higher-level program manages generations of the files, and
the higher-level notifies the emulator of a file of generation older than a file of generation (n−k), as the unnecessary file, when a file of generation (n) is stored in the virtual tape.

4. The computer system according to claim 1, wherein
the storage resource stores therein validity/invalidity information representing validity/invalidity for each data object, and
the emulator determines in the (B) whether the data object to be provided is valid or invalid, based on the validity/invalidity information corresponding to the data object.

5. The computer system according to claim 4, wherein
the emulator, in the (A), updates the validity/invalidity information corresponding to the unnecessary data object, from information representing validity to information representing invalidity.

6. The computer system according to claim 1, wherein
the higher-level program notifies the emulator of the unnecessary data object, and
the unnecessary data object in the (A) is a data object notified from the higher-level program.

7. The computer system according to claim 6, wherein
the higher-level program manages generations of the data objects, and
the higher-level program notifies the emulator of a data object of generation older than a data object of generation (n−k), as the unnecessary data object, when a data object of generation (n) is stored in the virtual tape.

8. The computer system according to claim 1, wherein the predetermined control information is data including data representing an end of the data object.

9. A computer program, which emulates a random medium which is a random access storage medium, on a virtual sequential medium which is a virtual sequential access storage medium, the computer program causing a computer to:
invalidates a random medium section storing an unnecessary data object in order to allow other data to be stored therein, when the unnecessary data object exists in the virtual sequential medium; and
provides, to a higher-level program that prevents the sequential medium from being partially invalidated, predetermined control information of smaller size than the unnecessary data object, in place of the unnecessary data object, when providing to the higher-level program the unnecessary data object.

10. A storage control method, comprising the steps in which:
an emulator that emulates a random medium which is a random access storage medium on a virtual sequential medium which is a virtual sequential access storage medium invalidates a random medium section storing an unnecessary data object in order to allow other data to be stored therein, when the unnecessary data object exists in the virtual sequential medium; and
the emulator provides, to a higher-level program that prevents the sequential medium from being partially invalidated, predetermined control information of smaller size than the unnecessary data object, in place of the unnecessary data object, when providing to the higher-level program the unnecessary data object.
